(19) United States
(12) Patent Application Publication
(10) Pub. No.: US 2020/0247310 A1
(43) Pub. Date: Aug. 6, 2020

(54) Tailgate service light

(71) Applicant: Loyd Earl Terry, Edwards, MS (US)

(72) Inventor: Loyd Earl Terry, Edwards, MS (US)

(21) Appl. No.: 16/350,911

(22) Filed: Feb. 1, 2019

(51) Int. Cl. B60Q 1/30; B60Q 1/26; B60Q 1/00; F21V 31/00; F21V 23/00; F21S 43/14; F21S 43/19

(52) U.S. Cl. CPC B60Q 1/305; B60Q 1/2669; B60Q 1/2696; B60Q 1/0088; F21Y 2115/10; F21V 23/001; F21S 43/14; F21S 43/195; F21V 31/005

(57) ABSTRACT

A vehicle service light. The vehicle service light may include a light configured to be mountable in a tailgate or rear hatch of a vehicle such that light emitting from the light is directed in a general direction of a trailer hitch/receiver mounted to the vehicle; and a wiring harness, wherein the wiring harness is configured to operatively connect the light to a vehicle power source.

### CROSS-REFERENCE TO RELATED APPLICATIONS

This application is related and claims priority to U.S. Patent Application Ser. No. 62/761,597 filed Mar. 31, 2018.

### TECHNICAL FIELD

The presently disclosed subject matter relates generally to a vehicle service light, and in particular to a tailgate/rear hatch door service light.

### BACKGROUND

Truck tailgates, SUV/van rear hatches, and the like have evolved over time from, for example, single hull to a double hull body. Additionally, towing packages for various vehicles have also evolved and become more advanced and safety oriented. Most tailgates, rear hatches, and the like may have some lighting available, e.g., truck cab light, license plate light. However, in low or no light situations, even with the previously mentioned light sources, it can be very difficult to adequately see the hitch area of the vehicle and trailer when trying to hitch or unhitch the trailer with the tow vehicle. Often, one has to use a flashlight, which may require them to hold the flashlight with one hand, while attempting to hitch or unhitch the trailer with the vehicle using just their one free hand, or try to hold the flashlight precariously in one's mouth or otherwise, thus making it a difficult and potentially dangerous process.

Therefore, there is a need for a way to make it safer and easier to see what one is doing when hitching or unhitching a trailer in low or no light environments.

### SUMMARY

In one embodiment, a vehicle service light is provided. The vehicle service light may include a light configured to be mountable in a tailgate or rear hatch of a vehicle such that light emitting from the light is directed in a general direction of a trailer hitch/receiver mounted to the vehicle; and a wiring harness, wherein the wiring harness is configured to electronically connect the light to a vehicle power source. The tailgate service light may further include a light seal, wherein the light seal may be configured to form a substantially waterproof or resistant seal between the light and the tailgate or rear hatch of the vehicle. The light seal may include a rubber grommet. The light may include an LED light. The wiring harness may include a disconnect at a point between the power source and light. The light may be configured to be mounted in a hole formed in about a center point of the tailgate or rear hatch of the vehicle. The light may be configured to be mounted to the tailgate or rear hatch of the vehicle, such that the light may be may be may be angled downward from horizontal. The light may be electrically connected to a cargo light switch of the vehicle by the wiring harness. The wiring harness may be electrically connected to the light via a light plug.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a tailgate showing a hole for placement of a vehicle service light in accordance with an embodiment of the invention;

FIG. 2 illustrates a tailgate showing a light seal installed about the hole for placement of the vehicle service light in accordance with an embodiment of the invention;

FIG. 3 illustrates a tailgate with the vehicle service light installed therein in accordance with an embodiment of the invention;

FIG. 4 illustrates a tailgate with a vehicle service light installed therein and a wiring harness in accordance with an embodiment of the invention; and

FIGS. 5 and 6 illustrate views of the vehicle service light in operation showing light emitting from the light being directed in a general direction of a trailer hitch/receiver mounted to the vehicle in accordance with an embodiment of the invention.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The vehicle service light of the present disclosure is designed to provide lighting to, for example, a tow vehicle receiver and trailer hitch area when hitching or unhitching a trailer (or other towable item) with the tow vehicle. The vehicle service light may be strategically placed to provide suitable lighting for hitching or unhitching a trailer or other item with the tow vehicle, for example, a boat trailer, camper, farm equipment, hunting and/or other towable item or equipment.

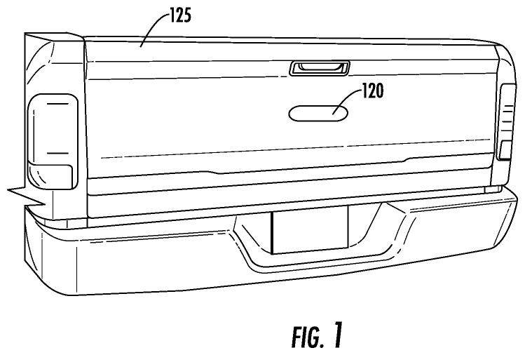

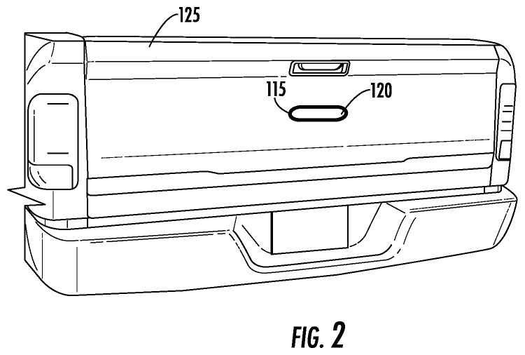

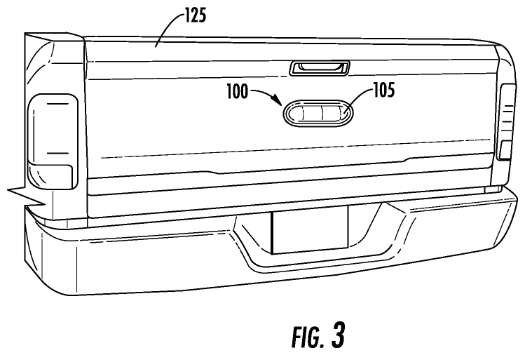

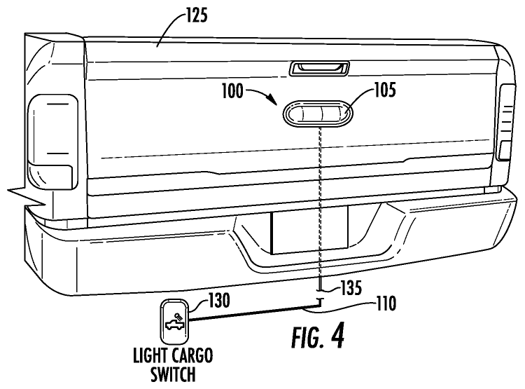

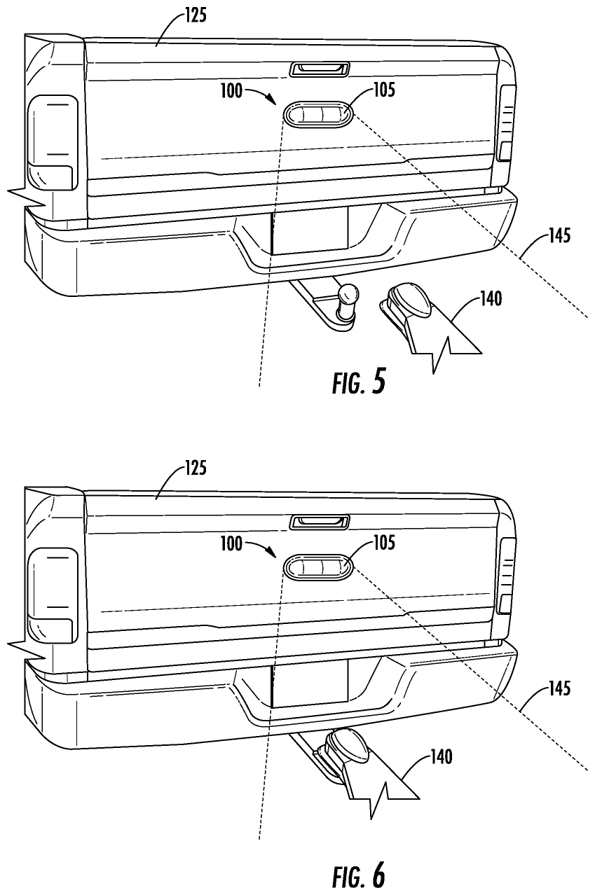

Referring now to the FIGS. 1-6, in one embodiment a vehicle service light 100 is provided. The vehicle service light 100 may include a light 105 and wiring harness 110. The light 105 may be an LED light, or other suitable type and/or style of light. The vehicle service light 100 may further include a light seal 115, such as a silicon or rubber grommet, or the like.

In one embodiment, a hole 120 (or holes) may be formed in a tailgate/rear hatch 125 of a tow vehicle. In one non-limiting example, hole 120 may be about 6¾ inches long by about 2½ inches wide. However, the shape and/or size of the light 105 of the vehicle service light 100 determines the size and shape of the hole 120 to be cut or manufactured into the tow vehicle's tailgate/rear hatch 125. In one embodiment, a wiring hole(s) (not shown) for the wiring of wiring harness 110, may also be formed in the vehicle to allow for passage of the wiring from the light 105 to a power source 130, such as a switchable power source. In one example, the wiring may be combined or connected with a cargo light switch of the tow vehicle, wherein the vehicle service light 100 may be active by turning on the tow vehicle's cargo light switch. The vehicle service light 100 may further include one or more wire hole grommets (not shown), such as rubber, silicone, or the like, to protect the wiring from the metal edges of the holes and/or to provide a waterproof/resistant seal. The vehicle service light 100 may also further include a wire disconnect 135 to allow for easy removal of the tailgate/rear hatch 125. Wire disconnect 135 may be located at a point between the light 105 and power source 130, and preferably at a point outside of, but close to, the vehicle's tailgate/rear door hatch 125. Thereby one could disconnect the wire disconnect 135, and then remove the tailgate/rear door hatch 125 without having to cut or remove any of the wires of wiring harness 110.

In one embodiment, the vehicle service light 100 may be integrated into the tow vehicle's tailgate/rear door hatch 125 at about a mid portion (relative to vertical and/or horizontal), and may be angled downward from horizontal an amount sufficient so as to not interfere with oncoming traffic behind the vehicle if the vehicle service light 100 were to be left on while in traffic.

To install the vehicle service light 100, hole 120 may be formed in the tailgate/rear door hatch 125. The light seal 115 may then be place about the perimeter of the hole 120. The wires of wiring harness 110 may be routed through hole 120 and the formed wiring holes. If needed, the wiring holes may be formed and wire hole grommets installed in the wiring holes prior to routing the wires of wiring harness 110. One end of the wires of wiring harness 120 is connected to the power source 130, such as a switchable power source (e.g., cargo light switch), and the other end is operatively connected to the light 105. Light 105 may be pre-wired to wiring harness 130 (hard wired), or wiring harness 130 may include a light plug and be attached to light 105 by a corresponding light plug (not shown). The light 105 may be secured to hole 120 by any suitable mechanism or technique. The presence of light seal 115 around hole 120 preferably forms a waterproof/resistant seal about the light 105 and hole 120.

In operation, when hitching or unhitching a trailer 140 with the tow vehicle, an operator would activate the vehicle service light 100 by, for example, turning on the power source 130, e.g., turn on the cab light, to provide light 145 to the tow vehicle receiver and trailer hitch area, and then proceed with hitching or unhitching the trailer 140 with the tow vehicle. Once finished the operator would deactivate the vehicle service light 100 by, for example, turning off the power supply 130.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A vehicle service light, comprising:
a. a light configured to be mountable in a tailgate or rear hatch of a vehicle such that light emitting from the light is directed in a general direction of a trailer hitch/receiver mounted to the vehicle; and
b. a wiring harness, wherein the wiring harness is configured to electronically connect the light to a vehicle power source.

2. The tailgate service light of claim 1, further comprising a light seal, wherein the light seal is configured to form a substantially waterproof or resistant seal between the light and the tailgate or rear hatch of the vehicle.

3. The tailgate service light of claim 2, wherein the light seal comprises a rubber grommet.

4. The tailgate service light of claim 1, wherein the light comprises an LED light.

5. The tailgate service light of claim 1, wherein the wiring harness comprises a disconnect at a point between the power source and light.

6. The tailgate service light of claim 1, wherein the light is configured to be mounted in a hole formed in about a center point of the tailgate or rear hatch of the vehicle.

7. The tailgate service light of claim 6, wherein the light is configured to be mounted to the tailgate or rear hatch of the vehicle, such that the light can angle downward from horizontal.

8. The tailgate service light of claim 1, wherein the light is electrically connected to a cargo light switch of the vehicle by the wiring harness.

9. The tailgate service light of claim 1, wherein the wiring harness is electrically connected to the light via a light plug.
